(19) United States
(12) Patent Application Publication
(10) Pub. No.: US 2006/0077130 A1
(43) Pub. Date: Apr. 13, 2006

(54) Plasma display apparatus and driving method thereof

(75) Inventor: Byung Joon Rhee, Yongin-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/246,107

(22) Filed: Oct. 11, 2005

(30) Foreign Application Priority Data
Oct. 11, 2004 (KR) 10-2004-0081133

(51) Int. Cl. G09G 3/28

(52) U.S. Cl. 345/60

(57) ABSTRACT

The present invention relates to a plasma display apparatus and driving method thereof, and more particularly, to a plasma display apparatus that generates a sustain pulse, and driving method thereof. The present invention controls a rising time of a sustain pulse applied to electrodes according to a load of a video signal, such as an APL value, a display area or the number of a sustain pulse. The plasma display apparatus and the driving method of the present invention controls a rising time of a sustain pulse according to a load. Therefore, a bright afterimage can be prohibited and the picture quality can be improved.

### CROSS-REFERENCES TO RELATED APPLICATIONS

This Nonprovisional application claims priority under 35 U.S.C. § 119(a) on Patent Application No. 2004-81133 filed in Korea on Oct. 11, 2004, the entire contents of which are hereby incorporated by reference.

### BACKGROUND OF THE INVENTION

1. Field of the Invention

The present invention relates to a plasma display apparatus and driving method thereof, and more particularly, to a plasma display apparatus that generates a sustain pulse, and driving method thereof.

2. Background of the Related Art

In general, a plasma display panel comprises a front substrate and a rear substrate comprised of soda-lime glass. Barrier ribs formed between the front substrate and the rear substrate partition discharge cells. An inert gas injected into the discharge cells, such as helium-xeon (He—Xe) or helium-neon (He—Ne), generates a discharge with a high frequency voltage. When the discharge is finished, the inert gas generates vacuum ultraviolet rays. Vacuum ultraviolet rays excite phosphors formed between the barrier ribs, thus displaying images.

FIG. 1 is a perspective view schematically showing the construction of a conventional plasma display panel.

As shown in FIG. 1, the conventional plasma display panel comprises a front panel and a rear panel. The front panel comprises a front glass substrate 10. The rear panel comprises a rear glass substrate 20. The front panel and the rear panel are parallel to each other with a predetermined distance therebetween.

On the front glass substrate 10 is formed a sustain electrode pair 11, 12 for sustaining the emission of a cell through mutual discharge. The sustain electrode pair comprises the scan electrode 11 and the sustain electrode 12. The scan electrode 11 comprises a transparent electrode 11a formed of a transparent ITO material and a bus electrode 11b formed of a metal material. The sustain electrode 12 comprises a transparent electrode 12a formed of a transparent ITO material and a bus electrode 12b formed of a metal material.

The scan electrode 11 receives a scan signal for scanning a panel and a sustain signal for sustaining a discharge. The sustain electrode 12 mainly receives a sustain signal. A dielectric layer 13a is formed on the sustain electrode pair 11,12, and it functions to limit the discharge current and provides insulation between the electrode pairs. A protection layer 14 is formed on a top surface of the dielectric layer 13a and is formed of magnesium oxide (MgO) so as to facilitate a discharge condition.

On the rear glass substrate 20 are disposed address electrodes 22 crossing the sustain electrode pair 11, 12. A dielectric layer 13b is formed on the address electrodes 22 and functions to provide insulation between the address electrodes 22. Barrier ribs 21 are formed on the dielectric layer 13b and partition discharge cells. R, G and B phosphor layer 23 are coated between the barrier ribs 21 and the barrier ribs 21 and radiate a visible ray for displaying images.

The front glass substrate 10 and the rear glass substrate 20 are combined together by a sealing material. An inert gas, such as helium (He), neon (Ne) or xeon (Xe), is injected into the plasma display panel on which an exhaust process has been performed.

A method of representing image gray levels of the conventional plasma display panel constructed above will be described below with reference to FIG. 2.

FIG. 2 is a view for illustrating a method of representing image gray levels of the conventional plasma display apparatus.

As shown in FIG. 2, the conventional plasma display apparatus represents gray levels with one frame being divided into several sub-fields with a different number of emissions. Each sub-field is divided into a reset period for uniformly generating a discharge, an address period for selecting a cell to be discharged, and a sustain period for implementing gray levels depending on the number of discharges. For example, if it is sought to display images with 256 gray levels, a frame period (16.67 ms) corresponding to 1/60 seconds is divided into eight sub-fields SF1 to SF8, as shown in FIG. 2. Each of the eight sub-fields is again divided into a reset period, an address period and a sustain period. The reset period and the address period of each sub-field are the same every sub-field, whereas the sustain period thereof is increased in the ratio of 2ⁿ (where, n=0, 1, 2, 3, 4, 5, 6, 7) in each sub-field.

FIG. 3 is a view for illustrating a driving method of the conventional plasma display apparatus.

As shown in FIG. 3, the conventional plasma display apparatus is driven with it being divided into an reset period for resetting the entire cells, an address period for selecting a cell to be discharged and a sustain period for sustaining the discharge of a selected cell.

In a set-up period SU of the reset period, a ramp-up waveform (Ramp-up) is applied to all the scan electrodes Y at the same time. The ramp-up waveform causes a discharge to be generated within cells of the entire screen. The set-up discharge causes positive wall charges to be accumulated on the address electrodes X and the sustain electrodes Z, and negative wall charges to be accumulated on the scan electrodes Y.

In a set-down period SD of the reset period, a ramp-down waveform (Ramp-down) causes a weak erase discharge to be generated within cells, thus erasing some of wall charges that are redundantly formed. The set-down discharge causes wall charges of the degree in which an address discharge can be generated stably to uniformly remain within the cells.

In the address period, while negative scan pulses are sequentially applied to the scan electrodes Y, a positive data pulse (data) is supplied to the address electrodes X in synchronization with the scan pulses. As a voltage difference between the scan pulse and the data pulse and a wall voltage generated in the reset period are added, an address discharge is generated within cells to which the data pulse is applied. Furthermore, wall charges of the degree in which a discharge can be generated when a sustain voltage is applied are formed within cells selected by the address discharge. The sustain electrode Z is supplied with a positive DC voltage (Zdc) such that an erroneous discharge is not generated between the sustain electrode Z and the scan electrodes Y by reducing a voltage difference between the scan electrodes Y and the sustain electrode Z during the set-down period and the address period.

In the sustain period, sustain pulses (sus) are alternately applied to the scan electrodes Y and the sustain electrode Z. In cells selected by the address discharge, a sustain discharge is generated between the scan electrodes Y and the sustain electrode Z whenever the sustain pulse is applied as a wall voltage within cells and the sustain pulse are added.

After the sustain discharge is completed, a ramp waveform (erase) with a narrow pulse width and a low voltage level is applied to the sustain electrode Z, erasing wall charges remaining within the cells of the entire screen.

FIG. 4 is a view for illustrating local afterimages gene generated in the conventional plasma display panel.

As shown in FIG. 4, in the case where a first window pattern corresponding to a specific gray level is displayed at a central portion 200a of a display surface 200 of the conventional plasma display apparatus, that is, an Average Picture Level (APL) value is low, the conventional plasma display apparatus enhances the brightness of a predetermined window pattern by increasing the number of allotted sustain pulses. Therefore, the conventional plasma display apparatus can improve a contrast characteristic.

In the case where a second window pattern corresponding to a specific gray level is displayed on the entire screen 200b of the display surface 200 of the conventional plasma display apparatus, that is, when the APL value becomes high, the conventional plasma display apparatus lowers the brightness of the entire screen 200b of the display surface 200 by reducing the number of allotted sustain pulses. Therefore, the conventional plasma display apparatus can save consumption power. In this case, the first window pattern that had been displayed at a portion 200a of the display surface 200 is represented as an afterimage 200c. This local bright afterimage 200c is represented since emission efficiency of phosphors is different depending on a distribution region of the phosphors upon discharge.

That is, phosphors existing between barrier ribs comprise a sidewall phosphor material existing on the lateral side of the barrier ribs, and a lower phosphor material existing on a dielectric material between the barrier ribs. A brightness width and a return time of each of the sidewall phosphor material and the lower phosphor material are decided by the initial aging degree. In this case, the brightness width refers to a brightness difference from the maximum emission to the minimal emission of phosphor. The return time refers to a return time from the maximum emission to the minimal emission of phosphors. That is, since initial aging is generated by a surface discharge, the degree of degradation of the sidewall phosphor material is greater than that of the lower phosphor material. Therefore, the brightness width and the return time of the sidewall phosphor material are smaller than those of the lower phosphor material.

As describe above, the brightness width and the return time of the sidewall phosphor material are smaller than those of the lower phosphor material. Therefore, if a discharge is generated on the entire screen after a window pattern of the highest brightness is displayed, a bright afterimage is generated due to mismatch in a brightness width and a return time between the sidewall phosphor material and the lower phosphor material of a discharge cell of the central portion 200a of the screen.

### SUMMARY OF THE INVENTION

Accordingly, the present invention has been made in view of the above problems occurring in the prior art, and it is an object of the present invention to provide a plasma display apparatus in which a bright afterimage can be prohibited and driving method thereof.

To achieve the above object, a plasma display apparatus according to the present invention comprises a load calculator that receives a video signal and calculates a load of the video signal, and a rising time controller that controls a rising time of a sustain pulse according to the load.

The load calculator receives the video signal and calculates an APL value. The rising time controller controls the rising time of the sustain pulse to increase as the APL value becomes low.

The rising time controller sets the lowest rising time of the sustain pulse to 200 ns and set the highest rising time of the sustain pulse to 600 ns.

The load calculator receives the video signal and calculates a display area of the video signal. The rising time controller controls the rising time of the sustain pulse to increase as the display area becomes small.

The load calculator receives the video signal, calculate an APL value of the video signal, and allot the number of the sustain pulse according to the APL value. The rising time controller controls the rising time of the sustain pulse to increase as the number of the allotted sustain pulses increases.

A driving method of a plasma display apparatus according to the present invention comprises the steps of receiving a video signal and calculating a load of the video signal, and deciding a rising time of a sustain pulse according to the load of the video signal.

To calculate the load of the video signal is to calculate an APL value of the video signal, and deciding the rising time of the sustain pulse according to the APL value.

As the APL value becomes low, the rising time of the sustain pulse increases.

To calculate the load of the video signal is to calculate a display area of the video signal, and deciding the rising time of the sustain pulse according to the display area.

As the display area becomes small, the rising time of the sustain pulse is set to increase.

To calculate the load of the video signal is to calculate the number of a sustain pulse according to an APL value of the video signal, and deciding the rising time of the sustain pulse according to the number of the allotted sustain pulse.

As the number of the allotted sustain pulse increases, the rising time of the sustain pulse is set to increase.

After a sub-field corresponding to the video signal is mapped, the number of a sustain pulse of each sub-field is allotted. A rising time of a sustain pulse allotted to at least one of a plurality of sub-fields is controlled according to the number of the sustain pulse allotted to each sub-field.

A rising time of a sustain pulse allotted to a sub-field with a high brightness weight is set to increase.

A rising time of a sustain pulse allotted to a sub-field with the highest brightness weight is set to increase.

A plasma display apparatus according to the present invention comprises a sub-field mapping unit that receives a video signal and calculates a sub-field corresponding to a gray level, a load calculator that receives information on the sub-field mapped by the sub-field mapping unit, and allots the number of a sustain pulse of each sub-field, and a rising time controller that controls a rising time of a sustain pulse allotted to at least one of a plurality of sub-fields according to the number of the sustain pulse allotted to each sub-field.

The rising time controller controls a rising time of a sustain pulse allotted to a sub-field with a high brightness weight to increase.

The rising time controller controls a rising time of a sustain pulse allotted to a sub-field with the highest brightness weight to increase.

### BRIEF DESCRIPTION OF THE DRAWINGS

Further objects and advantages of the invention can be more fully understood from the following detailed description taken in conjunction with the accompanying drawings in which:

FIG. 1 is a perspective view schematically showing the construction of a conventional plasma display panel;

FIG. 2 is a view for illustrating a method of representing image gray levels of the conventional plasma display apparatus;

FIG. 3 is a view for illustrating a driving method of the conventional plasma display apparatus;

FIG. 4 is a view for illustrating local afterimages gene generated in the conventional plasma display panel;

FIG. 5 is a view for illustrating an Energy Recovery (ER)-up time of a sustain pulse;

FIG. 6 is a view for illustrating a rising time of the sustain pulse and the degree of degradation of phosphors;

FIG. 7 is a diagram showing the relation between a rising time of the sustain pulse and an opposite discharge;

FIG. 8 is a view for illustrating a driving method of a plasma display apparatus according to the present invention;

FIG. 9 shows the operation of a plasma display apparatus of the present invention depending on a sub-field;

FIG. 10 is a block diagram showing the construction of a plasma display apparatus according to the present invention; and

FIG. 11 is a flowchart illustrating a driving method of the plasma display apparatus according to the present invention.

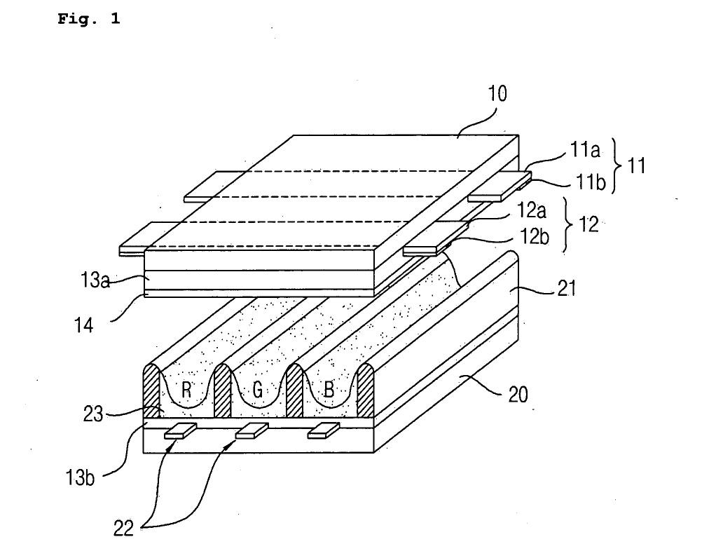

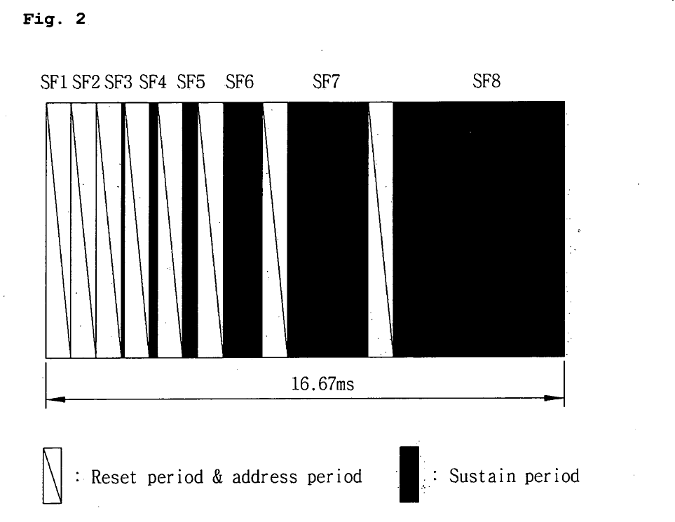

### DETAILED DESCRIPTION OF THE PREFERRED EMBODIMENT

The present invention will now be described in detail in connection with preferred embodiments with reference to the accompanying drawings.

A plasma display apparatus and driving method thereof according to the present invention controls an ER-up time of a sustain pulse according to the load of a video signal. The load can refer to an APL value, an area on which images are displayed, the number of allotted sustain pulses and the like. If the APL value is high, an area on which images are displayed is large and the number of allotted sustain pulses is low. Meanwhile, if the APL value is low, an area on which images are displayed is small and the number of allotted sustain pulses is low.

The relation between the ER-up time of the sustain pulse and the degree of degradation of phosphors will be first described.

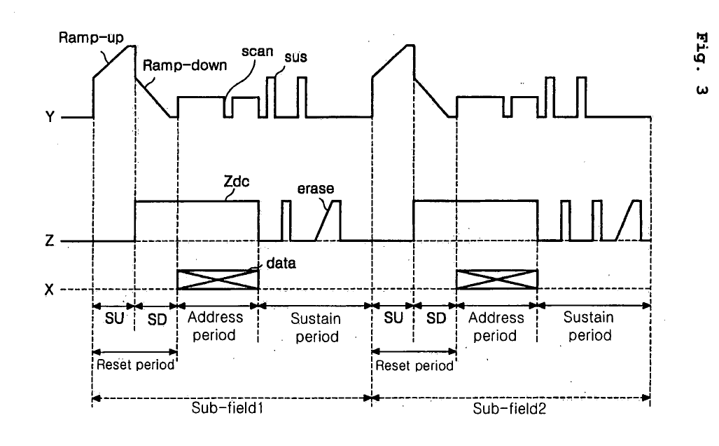

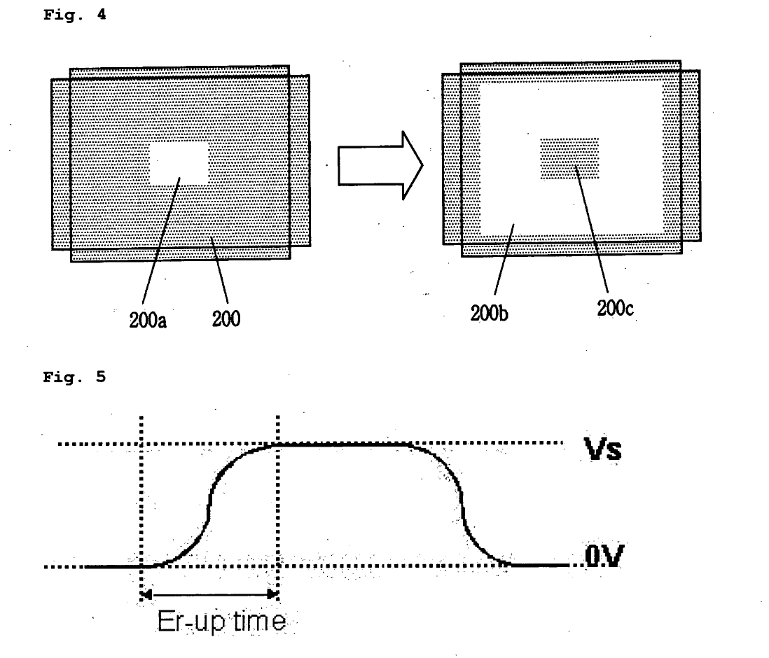

FIG. 5 is a view for illustrating an ER-up time of a sustain pulse. A sustain pulse of FIG. 5 is alternately applied to the scan electrodes Y and the sustain electrodes Z in the sustain period of FIG. 3. The ER-up time of the sustain pulse refers to a time taken to rise from the lowest level (0V) to the highest level (Vs) (a sustain voltage) of the sustain pulse. Therefore, the present invention controls the time taken to rise from the lowest level to the highest level of the sustain pulse, i.e., the ER-up time of the sustain pulse (hereinafter, referred to as a “rising time of a sustain pulse”) depending on an APL value.

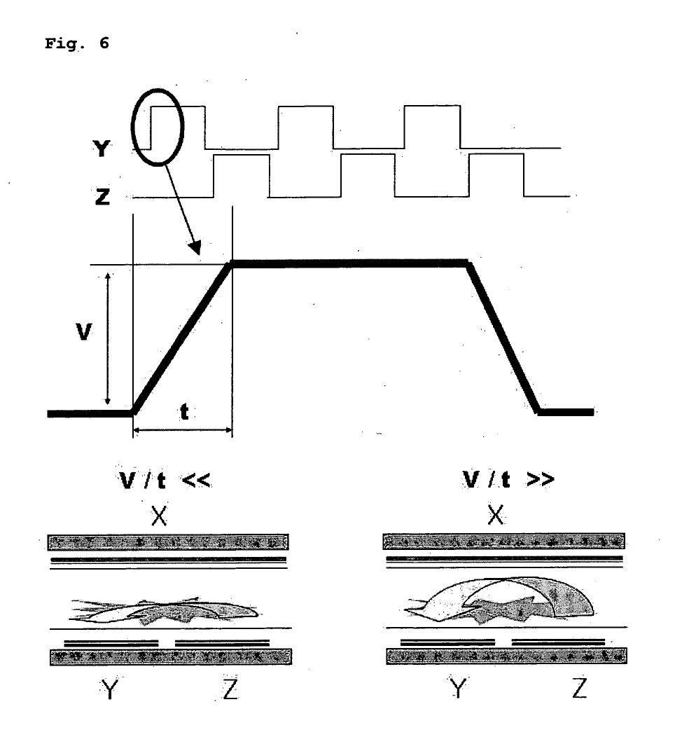

FIG. 6 is a view for illustrating the rising time of the sustain pulse and the degree of degradation of phosphors.

As shown in FIG. 6, the discharge trace can vary depending on the rising time of the sustain pulse. That is, as shown on a lower left side of FIG. 6, if the sustain pulse is alternately applied to the scan electrodes Y and the sustain electrodes Z during the sustain period and a surface discharge is generated between the scan electrodes Y and the sustain electrodes Z accordingly, an opposite discharge generated between one of the scan electrodes Y and the sustain electrodes Z and the address electrodes X is reduced as V/t is lowered, i.e., a rising time (t) is increased. To the contrary, if V/t increases, i.e., the rising time (t) becomes low, the opposite discharge generated between one of the scan electrodes Y and the sustain electrodes Z and the address electrodes X is increased. As describe above, the opposite discharge that is increased as the rising time (t) increases accelerates the degradation of the lower phosphor material in comparison with the sidewall phosphor material.

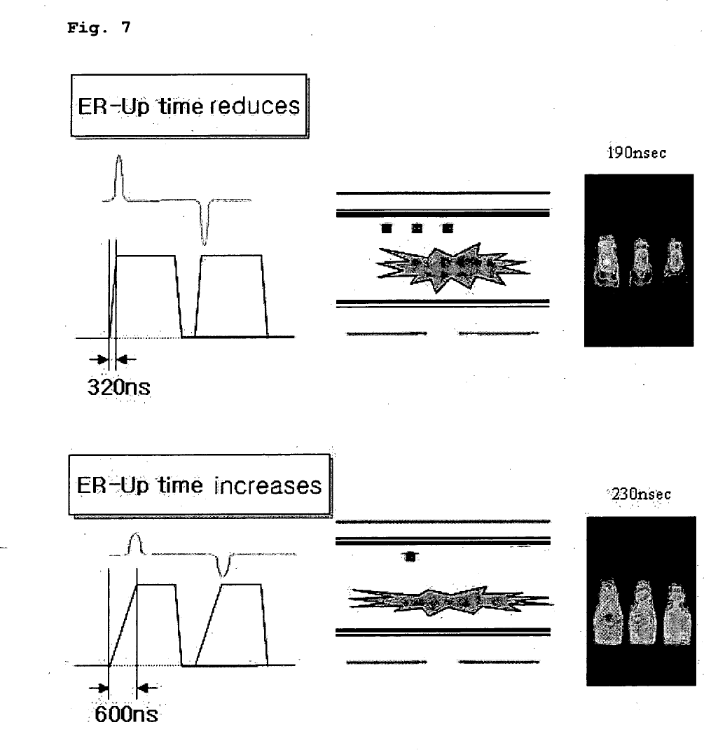

FIG. 7 is a diagram showing the relation between a rising time of the sustain pulse and an opposite discharge.

From FIG. 7, it can be seen that a discharge generated by a sustain pulse whose rising time is 600 ns has an area greater than that of a discharge generated by a sustain pulse whose rising time is 320 ns. That is, the reason why the discharge area is reduced as the rising time is lowered is because an opposite discharge is generated in a surface discharge process.

As described above with reference to FIGS. 6 and 7, if the rising time of the sustain pulse is reduced, the opposite discharge is generated. It is thus possible to overcome a difference in the degree of degradation due to initial aging between the sidewall phosphor material and the lower phosphor material.

Meanwhile, the bright afterimage is generated when an image with a low APL value and a high brightness and an image with a high APL value and a low brightness are displayed. Therefore, the present invention reduces a difference in the degree of degradation between the sidewall phosphor material and the lower phosphor material by controlling the rising time of the sustain pulse depending on the APL value. It is thus possible to remove the bright afterimage.

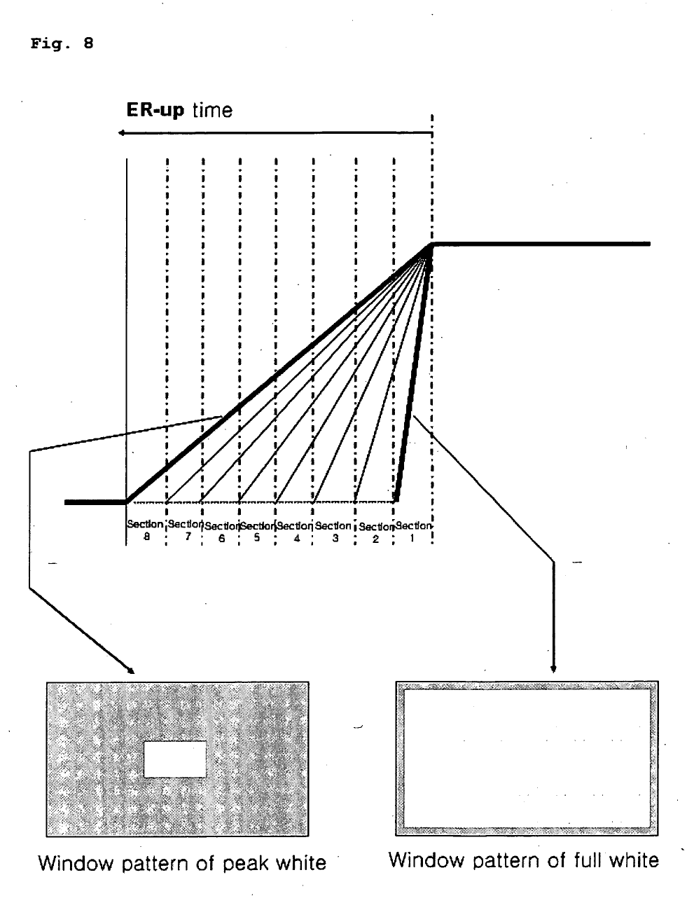

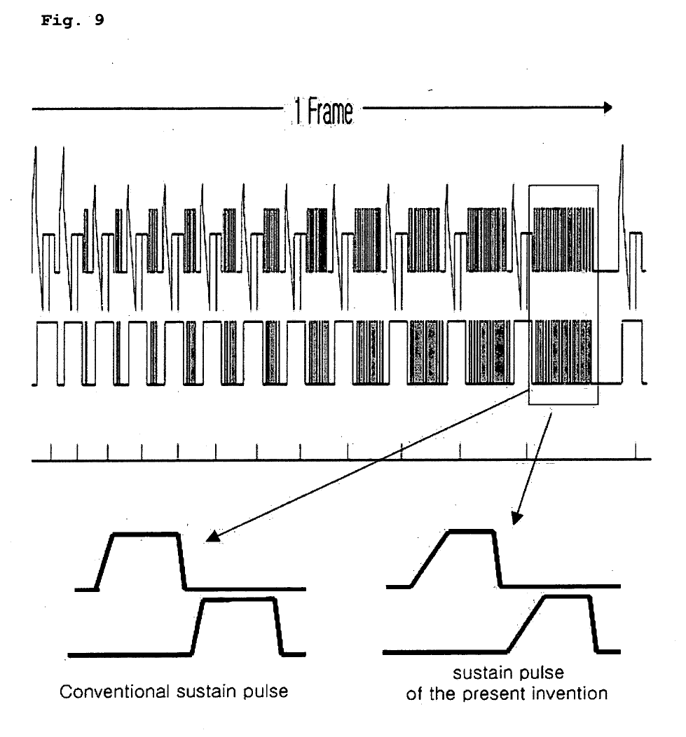

FIG. 8 is a view for illustrating a driving method of a plasma display apparatus according to the present invention.

As shown in FIG. 8, the plasma display apparatus of the present invention divides the entire APL value into eight sections and controls the rising time of a sustain pulse in accordance with the APL value. The APL value is lowered from the section 1 to the section 8. Therefore, the section 1 is a region of the highest APL value and the section 8 is a region of the lowest APL value. The plasma display apparatus according to the present invention increases the rising time of the sustain pulse in a section with a low APL value due to a small display area, but increases the rising time of the sustain pulse in a section with a high APL value due to a large display area.

Therefore, when a window pattern having a brightness of the peak white whose APL value is the lowest and the number of allotted sustain pulses is the largest is displayed, the plasma display apparatus of the present invention controls an opposite discharge to be less generated during a surface discharge by increasing the rising time of the sustain pulse. Furthermore, when a window pattern having a brightness of the full white whose APL value is the highest and the number of allotted sustain pulses is the smallest is displayed, the plasma display apparatus of the present invention controls an opposite discharge to be much generated during a surface discharge by reducing the rising time of the sustain pulse.

Therefore, when the window pattern of the full white is displayed after the window pattern of the peak white is displayed, a bright afterimage in which an afterimage of the window pattern of the peak white is displayed can be reduced. In other words, when the window pattern of the peak white is displayed, phosphors generate the maximum emission. When the window pattern of the full white is displayed, phosphors generate the minimal emission. Since the degree of degradation of the sidewall phosphor material due to initial aging is greater than those of the lower phosphor material, the return time of the sidewall phosphor material is smaller than that of the lower phosphor material. Therefore, the sidewall phosphor material reaches the minimal emission faster than the lower phosphor material.

In this case, the plasma display apparatus of the present invention reduces the rising time of the sustain pulse when the window pattern of the full white is displayed so that the opposite discharge is generated relatively high during a surface discharge. Therefore, when the window pattern of the full white is displayed, the degradation of the lower phosphor material is greater than that of the sidewall phosphor material. The plasma display apparatus according to the present invention can offset a difference in the amount of degradation upon initial aging.

Meanwhile, if the APL value is high, an area on which images are displayed is great and the number of allotted sustain pulses is small. If the APL value is low, an area on which images are displayed is small and the number of allotted sustain pulses is great. Therefore, the plasma display apparatus of the present invention reduces the rising time of the sustain pulse as the APL value becomes high. In addition, the plasma display apparatus of the present invention reduces the rising time of the sustain pulse as the display area is increased. Furthermore, the plasma display apparatus of the present invention reduces the rising time of the sustain pulse as the number of allotted sustain pulses is small.

Table 1 shows rising times in respective sections when the APL value are eight sections according to the operation of the plasma display apparatus according to the present invention.

TABLE 1

| Section of | | | | | | | | |
|---|---|---|---|---|---|---|---|---|
| APL Value | Section 1 | Section 2 | Section 3 | Section 4 | Section 5 | Section 6 | Section 7 | Section 7 |
| Rising time of | 200 ns | 285.7 ns | 371.4 ns | 458 ns | 543.7 ns | 629.4 ns | 714.3 ns | 800 ns |
| sustain pulse | | | | | | | | |

As shown in Table 1, the range of the rising time is set to be from 200 ns to 800 ns and the rising time for each section of the APL value can be varied depending on a characteristic of a plasma display panel, a variable ability range of the rising time and the number of sections of an APL value.

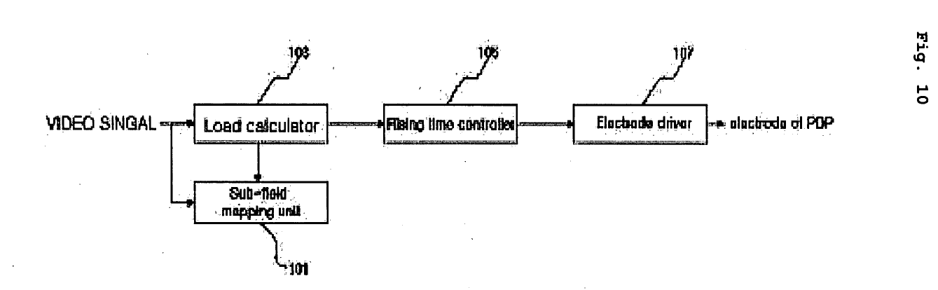

FIG. 9 shows the operation of a plasma display apparatus of the present invention depending on a sub-field.

As shown in FIG. 9, the plasma display apparatus of the present invention sets a rising time of a sustain pulse supplied in a sustain period of at least one or more of a plurality of sub-fields constituting one frame to be greater than those supplied in a sustain period of the remaining sub-fields. In this case, a sub-field to which a sustain pulse with a high rising time is supplied is preferably a sub-field with a relatively high brightness weight. Furthermore, a sub-field to which a sustain pulse with the highest rising time is supplied is preferably a sub-field with a relatively high brightness weight.

As describe above, if a rising time of a sustain pulse supplied a sub-field with a high brightness weight is increased, a surface afterimage can be effectively removed since an opposite discharge is less generated compared with the remaining sub-fields.

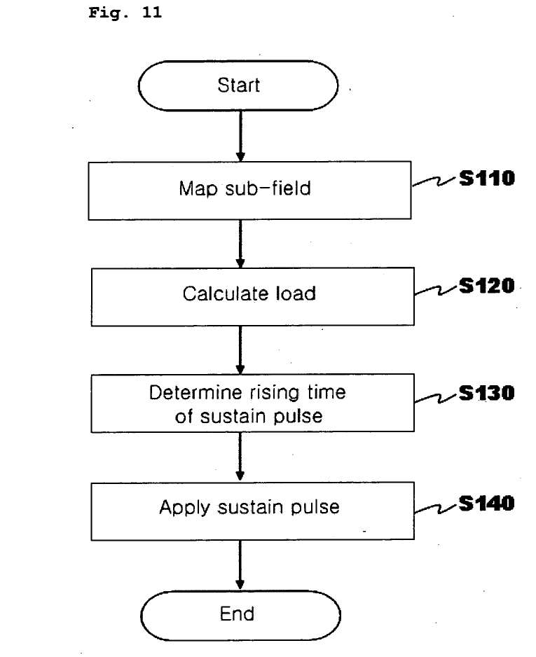

FIG. 10 is a block diagram showing the construction of a plasma display apparatus according to the present invention. As shown in FIG. 10, the plasma display apparatus of the present invention comprises a sub-field mapping unit 101, a load calculator 103, a rising time controller 105 and an electrode driver 107.

The sub-field mapping unit 101 receives a video signal and maps a corresponding sub-field to a gray level.

The load calculator 103 calculates an APL value or a display area based on a received video signal, and allots the number of sustain pulses of each sub-field using information on the sub-fields mapped by the sub-field mapping unit 101 and the APL value. The load calculator 103 increases the number of sustain pulses allotted to sub-fields when the APL value is low, but decreases the number of sustain pulses allotted to sub-fields when the APL value is high. The load calculator 103 calculates the APL value by calculating the ratio of the sum of gray levels of each cell to the number of cells the entire screen of which can be displayed. In addition, the load calculator 103 calculates the display area based on the number of cells selected in an address period.

The rising time controller 105 decides the rising time of the sustain pulse based on at least one of the APL value received from the load calculator 103, the display area and the number of allotted sustain pulses, and outputs a pulse application signal for supplying sustain pulses with the decided rising time as many as the allotted number. The rising time controller 105 increases the rising time of the sustain pulse when the APL value is low, increases the rising time of the sustain pulse when the display area is small, and decreases the rising period of the sustain pulse when the number of allotted sustain pulses is small.

The electrode driver 107 receives the pulse application signal from the rising time controller 105 and applies the sustain pulse formed according to the decided rising time to electrodes.

The plasma display apparatus constructed above according to the present invention sets a rising time of a sustain pulse supplied in a sustain period of at least one or more of a plurality of sub-fields constituting one frame to be greater than those supplied in a sustain period of the remaining sub-fields. In this case, a sub-field to which a sustain pulse with a high rising time is supplied is preferably a sub-field with a relatively high brightness weight. Furthermore, a sub-field to which a sustain pulse with the highest rising time is supplied is preferably a sub-field with a relatively high brightness weight.

That is, the sub-field mapping unit 101 of the present invention receives a video signal and maps a corresponding sub-field to a gray level.

The load calculator 103 receives information on the mapped sub-field from the sub-field mapping unit 101 and allots the number of sustain pulses of each sub-field.

The rising time controller 105 controls a rising time of a sustain pulse allotted to one or more of a plurality of sub-fields in accordance with the number of allotted sustain pulses of each sub-field, and outputs a pulse application signal for supplying the sustain pulses with the controlled rising time as many as the allotted number.

The electrode driver 107 receives the pulse application signal from the rising time controller 105 and applies the formed sustain pulse to electrodes according to the decided rising time.

In this case, the rising time controller 105 increases the rising time of a sustain pulse allotted to a sub-field with a high brightness weight. That is, the plasma display apparatus of the present invention increases the rising time of a sustain pulse when the number of sustain pulses is increased, so that the rising time of the sustain pulse allotted to the sub-field with a high brightness weight is increased.

The operation of the plasma display apparatus according to the present invention will be described below in detail.

FIG. 11 is a flowchart illustrating a driving method of the plasma display apparatus according to the present invention.

The sub-field mapping unit 101 first receives a video signal and maps a sub-field corresponding to a gray level at step S110. That is, the sub-field mapping unit 101 combines a plurality of sub-field constituting one frame and maps a gray level corresponding to the video signal to the sub-field.

The load calculator 103 then receives the video signal and calculates the load of the video signal at step S120. The load is at least one of an APL value of the video signal, a display area depending on the video signal, and the number of allotted sustain pulses. That is, the load calculator 103 calculates the APL value or the display area using a received vidFeo signal, and allottes the number of sustain pulses of each sub-field using information on the sub-fields mapped by the sub-field mapping unit 101 and the APL value.

The rising time controller 105 decides the rising time of the sustain pulse according to the load received form the load calculator 103, and outputs a pulse application signal for supplying sustain pulses with the decided rising time as many as the number allotted by the load calculator 103 at step S130. The rising time controller 105 increases the rising time of the sustain pulse as the APL value is low, increases the rising time of the sustain pulse as the display area is small, and reduces increases the rising time of the sustain pulse as the number of allotted sustain pulses is small. Furthermore, the rising time controller 107 increases the rising time of a sustain pulse allotted to a sub-field with a high brightness weight. The rising time controller 105 preferably increases the rising time of a sustain pulse allotted to a sub-field with the highest brightness weight.

The electrode driver 107 receives the pulse application signal from the rising time controller 105 and applies the formed sustain pulse according to the decided rising time at step S140.

As described above, according to a plasma display apparatus and driving method in accordance with the present invention, a bright afterimage is prohibited through control of a rising time of a sustain pulse according to a load, thereby improving the picture quality.

The invention being thus described, it will be obvious that the same is varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus, comprising:
a load calculator receiving a video signal and calculates a load of the video signal; and
a rising time controller controlling a rising time of a sustain pulse according to the load.

2. The plasma display apparatus as claimed in claim 1, wherein the load calculator receives the video signal and calculates an APL value of the video signal, and
the rising time controller controls the rising time of the sustain pulse to increase as the APL value becomes low.

3. The plasma display apparatus as claimed in claim 2, wherein the rising time controller sets the lowest rising time of the sustain pulse to 200 ns and sets the highest rising time of the sustain pulse to 600 ns.

4. The plasma display apparatus as claimed in claim 1, wherein the load calculator receives the video signal and calculates a display area of the video signal, and
the rising time controller controls the rising time of the sustain pulse to increase as the display area becomes small.

5. The plasma display apparatus as claimed in claim 1, wherein the load calculator receives the video signal, calculates an APL value of the video signal, and allots the number of the sustain pulse according to the APL value, and
the rising time controller controls the rising time of the sustain pulse to increase as the number of the allotted sustain pulses increases.

6. A driving method of a plasma display apparatus, comprising the steps of:
receiving a video signal and calculating a load of the video signal; and
deciding a rising time of a sustain pulse according to the load of the video signal.

7. The driving method as claimed in claim 6, wherein to calculate the load of the video signal is to calculate an APL value of the video signal,
and deciding the rising time of the sustain pulse according to the APL value.

8. The driving method as claimed in claim 7, wherein as the APL value becomes low, the rising time of the sustain pulse increases.

9. The driving method as claimed in claim 6, wherein to calculate the load of the video signal is to calculate a display area of the video signal,
and deciding the rising time of the sustain pulse according to the display area.

10. The driving method as claimed in claim 9, wherein as the display area becomes small, the rising time of the sustain pulse is set to increase.

11. The driving method as claimed in claim 6, wherein to calculate the load of the video signal is to allot the number of a sustain pulse according to an APL value of the video signal,
and deciding the rising time of the sustain pulse according to the number of the allotted sustain pulse.

12. The driving method as claimed in claim 11, wherein as the number of the allotted sustain pulse increases, the rising time of the sustain pulse is set to increase.

13. The driving method as claimed in claim 6, wherein after a sub-field corresponding to the video signal is mapped, the number of a sustain pulse of each sub-field is allotted, and
a rising time of a sustain pulse allotted to at least one of a plurality of sub-fields is controlled according to the number of the sustain pulse allotted to each sub-field.

14. The driving method as claimed in claim 13, wherein a rising time of a sustain pulse allotted to a sub-field with a high brightness weight is set to increase.

15. The driving method as claimed in claim 14, wherein a rising time of a sustain pulse allotted to a sub-field with the highest brightness weight is set to increase.

16. A plasma display apparatus, comprising:
a sub-field mapping unit receiving a video signal and calculates a sub-field corresponding to a gray level;
a load calculator receiving information on the sub-field mapped by the sub-field mapping unit, and allots the number of a sustain pulse of each sub-field; and
a rising time controller that controls a rising time of a sustain pulse allotted to at least one of a plurality of sub-fields according to the number of the sustain pulse allotted to each sub-field.

17. The plasma display apparatus as claimed in claim 16, wherein the rising time controller controls a rising time of a sustain pulse allotted to a sub-field with a high brightness weight to increase.

18. The plasma display apparatus as claimed in claim 17, wherein the rising time controller controls a rising time of a sustain pulse allotted to a sub-field with the highest brightness weight to increase.
